(19) United States
(12) Patent Application Publication
(10) Pub. No.: US 2014/0111344 A1
(43) Pub. Date: Apr. 24, 2014

(54) INTEGRATED GAS DETECTOR INTEGRATING WITH AUDIBLE AND VISUAL ALARMS

(71) Applicants: Fei Mao, Nangang District Harbin (CN); Weigang Wang, Nangang District Harbin (CN); Jilong Liu, Nangang District Harbin (CN)

(72) Inventors: Fei Mao, Nangang District Harbin (CN); Weigang Wang, Nangang District Harbin (CN); Jilong Liu, Nangang District Harbin (CN)

(73) Assignee: Harbin East Alarm Equipment Development Co., Ltd., Heilongjiang (CN)

(21) Appl. No.: 13/817,372

(22) PCT Filed: Nov. 15, 2011
(86) PCT No.: PCT/CN2011/082208

§ 371 Date: Apr. 1, 2013

(30) Foreign Application Priority Data
Jun. 22, 2011 (CN) 201110168986

(51) Int. Cl. G08B 21/16

(52) U.S. Cl. CPC G08B 21/16
USPC 340/632

(57) ABSTRACT

An integrated gas detector integrating with audible and visual alarms, comprising: an explosion-proof housing; a gas detection unit disposed in the explosion-proof housing and used for detecting the concentration of gas; and a signal transducing unit disposed in the explosion-proof housing and used for receiving and processing the signal indicating the concentration of gas from the gas detection unit. Wherein, the explosion-proof housing comprises a cylinder shaped upper cover (23) having an annular inward flange (231). The signal transducing unit and the gas detection unit are located at the two sides of the annular inward flange (231), and lean against the upper surface and the lower surface of the annular inward flange (231) respectively, and are connected detachably and fixedly to each other by a fastening device. The integrated gas detector integrating with audible and visual alarms further comprises a visual alarm unit and an audible alarm unit; the visual alarm unit being disposed at the side of the signal transducing unit; the audible alarm unit being disposed at the side of the gas detection unit; and when the signal transducing unit judges, basing on the signal indicating the concentration of gas, that the concentration of gas exceeds a preset alarm value, the visual alarm unit and the audible alarm unit will be triggered. The gas detector has such advantages as small size, low cost, corrosion-resistance and full functionality.

### FIELD OF INVENTION

The invention relates to a gas detector, more particularly, to an integrated gas detector integrating with audible and visual alarms.

### BACKGROUND OF THE INVENTION

In prior art, the gas detector itself has no function of audible and visual alarms. The exist gas detector has a gas detection unit and a signal transducing unit disposed in separate housing respectively, which leads to giant volume and high cost. For example, type EGM-1100S gas detector from RAE corp., US, type BS03II gas detector from HANWEI corp., Henan province, China.

However, as people concerning the life safety more and more, when preceding the gas detection, the exist gas detector should be connected with external audible and visual alarming devices which provides the function of audible and visual alarm, such as GBS-24V explosion-proof audible and visual annunciator from DONGFANG ALARM corp., and RS100 explosion-proof audible and visual annunciator from HANWEI corp., Henan province, China.

### SUMMARY OF THE INVENTION

The invention provides a new integrated gas detector integrating with audible and visual alarms, the integrated gas detector comprise a gas detecting portion, a signal transducing portion, an audible and visual alarming portion disposed within a common explosion-proof housing. The gas detector of the invention looks like an audible and visual annunciator and has such advantages as small size, low cost, corrosion-resistance and full functionality.

According to the first aspect of the invention, the invention provides an integrated gas detector integrating with audible and visual alarms, comprising:

an explosion-proof housing;

a gas detection unit disposed in the explosion-proof housing and used for detecting the concentration of gas; and a signal transducing unit disposed in the explosion-proof housing and used for receiving and processing the signal indicating the concentration of gas from the gas detection unit;

Wherein, the explosion-proof housing comprises a cylinder shaped upper cover having an annular inward flange; the signal transducing unit and the gas detection unit are located at the two sides of the annular inward flange, and lean against the upper surface and the lower surface of the annular inward flange respectively, and are connected detachably and fixedly to each other by a fastening device,

the integrated gas detector integrating with audible and visual alarms further comprises a visual alarm unit and an audible alarm unit; the visual alarm unit being disposed at the side of the signal transducing unit; the audible alarm unit being disposed at the side of the gas detection unit; and when the signal transducing unit judges, basing on the signal indicating the concentration of gas, that the concentration of gas exceeds a preset alarm value, the visual alarm unit and the audible alarm unit will be triggered.

According to one embodiment, the signal transducing unit may comprises a power supply board, a current board, and a control panel, and the visual alarm unit may comprises a signal board and a light emitting element provided on the signal board, the power supply board leans against the upper surface of the annular inward flange, and the power supply board, the current board, the signal board, as well as the control panel may be coupled with each other through pins for top to down and are detachably connected to each other by a fastening device, with insulated poles provided there between.

According to one embodiment, the integrated gas detector integrating with audible and visual alarms may further comprises a display unit, the display unit may comprises a display panel, and a LED assembly disposed on the display panel, the display panel may be provided over the control panel and connected by pins, the power supply board, the current board, the signal board, as well as the control panel and the display panel may be coupled with each other through pins from top to down and are detachably connected to each other by a fastening device, with insulated poles provided there between.

According to one embodiment, the gas detection unit may comprises a sensor, a sensor board, and a sensor control panel, wherein, the sensor control panel may leans against the lower surface of the annular inward flange and is connected detachably and fixedly to the fastening device, and the sensor is connected to the sensor board through pins, the sensor control panel is connected to the sensor board through pins.

According to one embodiment, the gas detection unit may further comprises a sensor fitting bracket, a first cross roundhead screw, and a copper connection pole, wherein, the sensor fitting bracket may be connected and secured by the threaded connection between the first cross roundhead screw and the copper connection pole, the copper connection pole may be connected securely to the fastening device through threaded connection.

According to one embodiment, the audible alarm unit may be disposed on the sensor board.

According to one embodiment, a threaded hole running through the annular inward flange may be formed, the threaded hole may be connected securely to a connecting screw through threaded connection, cables passing through a rubber seal ring and then passing through the connecting screw, and the inside of the connecting screw being filled with epoxy resin.

According to one embodiment, the explosion-proof housing may further comprises a lamp cover and a stainless threaded ring, the lamp cover over which a first O-ring seal is disposed being connected securely to the stainless threaded ring through threaded connection, the stainless threaded ring over which a second O-ring seal is disposed being connected securely to the top cover through threaded connection.

According to one embodiment, the explosion-proof housing may further comprises a bottom cover and a stainless mesh assembly, the bottom cover being fitted with a fourth O-ring seal at its bottom and being connected securely to the stainless mesh assembly through threaded connection, the top cover over which a third O-ring seal is disposed being connected securely to the bottom cover.

According to another aspect of the invention, the invention provides an integrated gas detector integrating with audible and visual alarms, comprising a gas detection unit, a signal transducing unit, an audible and visual alarm unit, and an explosion-proof housing, wherein,

the gas detection unit, the signal transducing unit, and the audible and visual alarm unit are disposed within the explosion-proof housing;

the gas detecting unit, the signal transducing unit, and the audible and visual alarming unit are connected sequentially;

the gas detection unit is used to detect the concentration of gas and deliver a signal comprising the concentration of gas to the signal transducing unit;

the signal transducing unit is used to convert the concentration of gas into a electrical signal for long-distance transmission; the signal indicating the concentration of gas will be transferred to the audible and visual alarming unit when the signal transducing unit judges that the concentration of gas exceeds the preset value;

the audible and visual alarming unit is used to convert the signal indicating the concentration of gas from signal transducing unit into audible and visual signal.

In practice, said explosion-proof housing includes a lamp cover, a first O-ring seal, a stainless threaded ring, a second O-ring seal, a top cover, a connecting nut, a rubber seal ring, a connecting screw, a bottom cover, a third O-ring seal, a fourth O-ring seal and a stainless mesh assembly;

said lamp cover over which the first O-ring seal is disposed is connected securely to said stainless threaded ring, said stainless threaded ring over which the second O-ring seal is disposed is connected securely to said top cover through threaded connection, said connecting nut is connected securely to said connecting screw through threaded connection, cables pass through said rubber seal ring and through said connecting screw, said connecting screw is filled with Epoxy resin said connecting screw is connected securely to said top cover through threaded connection, said top cover over which the third O-ring seal is disposed is connected securely to said bottom cover, said bottom cover is fitted with the fourth O-ring seal at its bottom and is connected securely to said stainless mesh assembly through threaded connection.

In practice, said gas detection unit comprises a sensor, a sensor board, a sensor control panel and a sensor fitting bracket, a first cross roundhead screw, a copper connection pole, and a two-ways copper pole;

said sensor is connected securely to said sensor board through pins, and said sensor control panel is connected securely to said sensor board through pins, said sensor fitting bracket is connected securely to said copper pole through threaded connection using said first cross roundhead screw, said copper connection pole is connected securely to said two-ways copper pole through threaded connection.

In practice, said signal transducing unit comprises a power supply board, a current board, a signal board, a second cross roundhead screw, a control panel, a display panel, and a LED assembly;

said power supply board is connected securely to said sensor control panel through a two-ways cooper pole; each of said power supply board, said current board, said signal board, said control panel and said display panel is connected through pins, with a first nylon pole, a second nylon pole, a third nylon pole, and a fourth nylon pole disposed therebetween; said fourth nylon pole is connected securely to said two-ways copper pole through said second cross roundhead screw, and said LED assembly is welded on said display panel.

In practice, said audible and visual alarming unit comprises a LED light emitting tube and a buzzer, said LED light emitting tube is welded to said signal board, and said buzzer is welded to the sensor board.

In practice, after diffusing, the gas to be detected enters into the explosion-proof housing through the stainless mesh assembly. Then, the sensor will detect the concentration of gas, the signal indicating the concentration of gas will be delivered to the sensor board control panel through sensor board after being amplified, then passing through power supply board, the current board, the signal board, and finally arrives at control panel. The control panel will convert the signal indicating the concentration of gas into visual concentration and deliver it to display panel for being read by user. The control panel converts the signal indicating the concentration of gas into 4-20 mA current output and input it to current board for transporting remotely. When the concentration of gas exceeds the preset value, the control will convert the signal indicating the concentration of gas into audible signal, visual signal and deliver it to the sensor board and the signal board respectively, then the signal board emits visual alarming signal through LED light emitting tube, and the sensor board emits audible alarming signal through buzzer.

The invention has the following advantages:

1. The integrated design of the housing leads to cost saving, having the functions of gas detection, concentration display, adjusting remotely on field through infrared, 4-20 mA signal output, RS485 signal output, audible and visual alarming synchronously, and is able to achieve detection of more than 100 gases through using different sensors. 2. The whole stainless housing design leads to corrosion resistance and suits for all kinds of bad environments. 3. Small volume, light weight, which means it can be fitted conveniently. 4. Integrated junction box wiring, thereby avoiding water entering into the housing of main circuit. 5. The invention has got certification of explosion-proof, the explosion-proof grade is ExdllCT6. The product suits for the zone 1 and zone 2 of places where exist combustible gas or explosive mixtures formed by steam and air with llA, B, C grade, T1˜T6 temperature. The gas detector of the invention can be applied to places where combustible gas or poisonous gas might leaking out, such as refineries, chemical plants, etc, and can provide a long-term continuous monitoring to those sites. In a word, it is an important monitoring device to guarantee the safety of people and the plant.

### BRIEF DESCRIPTION OF THE DRAWINGS

FIG. 1 shows the structure of the integrated gas detector integrating with audible and visual alarms of the invention.

### REFERENCE NUMBERS

1—LED assembly; 2—a second cross roundhead screw; 3—a third nylon pole; 3-1—a second nylon pole; 4-1—LED light emitting tube; 4—signal board; 5—a first O-ring seal; 6—a current board; 7—a first nylon pole; 8—power supply board; 9—two-ways copper pole; 10—sensor control panel; 11—a third O-ring seal; 12—sensor board; 13—buzzer; 14—sensor connecting broad; 15—a first cross roundhead screw; 16—sensor; 17—a fourth nylon pole; 18—display panel; 19—Control panel; 20—lamp cover; 21—stainless threaded ring; 22—a second O-ring seal; 23—top cover; 24—connecting nut; 25—connecting screw; 26—rubber seal ring; 27—cables; 28—copper connection pole 29—sensor fitting bracket; 30—bottom cover; 31—stainless mesh assembly; 32—a first O-ring seal; 231 annular inward flange

### DETAILED DESCRIPTION

The invention provides an integrated gas detector integrating with audible and visual alarms, the gas detector comprising a gas detection unit, a signal transducing unit, an audible and visual alarm unit disposed within a common explosion-proof stainless housing.

The integrated gas detector integrating with audible and visual alarms of the invention comprises a gas detection unit, a signal transducing unit, an audible and visual alarm unit and an explosion-proof housing, wherein,

said gas detection unit, said signal transducing unit, and said audible and visual alarm unit are disposed within said explosion-proof housing;

said gas detection unit, said signal transducing unit, and said audible and visual alarm unit are connected sequentially;

said gas detection unit is used to detect the concentration of gas and deliver a signal comprising the concentration of gas to said signal transducing unit;

said signal transducing unit is used to convert the concentration of gas into electrical signal for long-distance transmission; the signal indicating the concentration of gas will be transferred to said audible and visual alarm unit when the signal transducing unit judges that the concentration of gas exceeds a preset alarm value; said audible and visual alarm unit is used to convert the signal indicating the concentration of gas from signal transducing unit into audible and visual signal.

In the invention, the explosion-proof housing may comprises a cylinder shaped upper cover 23 having an annular inward flange 231. The signal transducing unit and the gas detection unit are located at the two sides of the annular inward flange 231, and lean against the upper surface and the lower surface of the annular inward flange 231 respectively, and are connected detachably and fixedly to each other by a fastening device.

The visual alarm unit(including LED light emitting tube 4-1, for example) is disposed at the side of the signal transducing unit; the audible alarm unit (including buzzer 13, for example) is disposed at the side of the gas detection unit; and when the signal transducing unit judges, basing on the signal indicating the concentration of gas, that the concentration of gas exceeds a preset alarm value, the visual alarm unit and the audible alarm unit will be triggered.

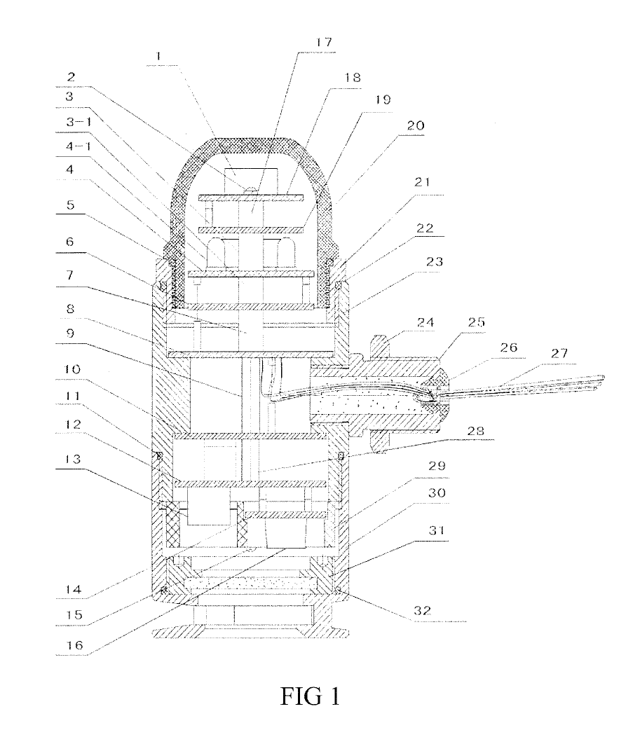

FIG. 1 shows the structure of the integrated gas detector integrating with audible and visual alarms according to one embodiment of the invention. Hereafter, the embodiment will be described with reference to the accompanying drawing.

As shown in FIG. 1, said explosion-proof housing includes a lamp cover 20, a first O-ring seal 5, a stainless threaded ring 21, a second O-ring seal 22, a top cover 23, a connecting nut 24, a connecting screw 25, a seal ring 26, a bottom cover 30, a third O-ring seal 11, a fourth O-ring seal 32 and a stainless mesh assembly 31. The lamp cover 20 over which the first O-ring seal 5 is disposed is connected securely to the stainless threaded ring 21. The stainless threaded ring 21 over which the second O-ring seal 22 is disposed is connected securely to the top cover 23 through threaded connection. The connecting nut 24 is connected securely to the connecting screw 25 through threaded connection. Cables 27 pass through the rubber seal ring 26 and through connecting screw 25. The connecting screw 25 is filled with epoxy resin to satisfy the requirement of explosion-proof. The connecting screw 25 is connected securely to top cover 23 through threaded connection; the top cover 23 over which the third O-ring seal 11 is disposed is connected securely to the bottom cover 30. The bottom cover 30 is fitted with the fourth O-ring seal 32 at its bottom and is connected securely to the stainless mesh assembly 31 through threaded connection.

Said gas detection unit comprises a sensor 16, a sensor board 12, a sensor control panel 10 and a sensor fitting bracket 29, a first cross roundhead screw 15, a copper connection pole 28, and a two-ways copper pole 9. The sensor 16 is connected securely to the sensor board 12 through pins. The sensor control panel 10 is connected securely to the sensor board 12 through pins. A sensor fitting bracket 29 is connected and secured by the threaded connection between the first cross roundhead screw 15 and the copper connection pole 28. The copper connection pole 28 is connected securely to the two-ways copper pole 9 through threaded connection.

Said signal transducing unit comprises a power supply board 8, a two-ways copper pole 9, a current board 6, a signal board 4, a control panel 19 and display panel 18, a LED assembly 1, a second cross roundhead screw 2, a fourth nylon pole 17. a second nylon pole 3, a third nylon pole 3-1, a first nylon pole 7. The power supply board 8 is connected securely to the sensor control panel 10 through the two-ways cooper pole 9. Each of the power supply board 8, current board 6, signal board 4, control panel 19 and display panel 18 is connected through pins, with a first nylon pole 17, a second nylon pole 3, a third nylon pole 3-1, a fourth nylon pole 17 disposed therebetween. Said fourth nylon pole 7 is connected securely to the two-ways copper pole 9 through the second cross roundhead screw 2, and the LED assembly 1 is welded on the display panel 18.

Said audible and visual alarm unit comprises a signal board 4, a LED light emitting tube 4-1, a sensor board 12 and buzzer 13. The LED light emitting tube 4-1 is welded to signal board 4, and the buzzer 13 is welded to sensor board 12.

Said lamp 20 may either be used as the display window of LED assembly 1, or be used as an alarm lamp cover of LED light emitting tube 4-1.

In implement, the top of said lamp cover 20 may be a flat top surface, with the main body of which having red color.

In implement, the stainless mesh assembly 31 may either be used as the inlet of the gas entering the sensor 16, or be used as a port of the buzzer 13 for emitting sound.

The gas to be detected enters into explosion-proof housing through the stainless mesh assembly 31 after diffusing. Then, the sensor 16 will detect the concentration of gas, the signal indicating the concentration of gas will be delivered to sensor board control panel 10 through sensor board 12 after being amplified, passing through power supply board 8, current board 6, signal board 4, and finally arrives at control panel 19. The control panel 19 will convert the signal indicating the concentration of gas into visual concentration and deliver it to display panel 18 for being read by user. In particularly, the control panel 19 converts the signal indicating the concentration of gas into 4-20 mA current output and input it to current board 6 for transporting remotely. When the concentration of gas exceeds the preset value, the control 19 will convert the signal indicating the concentration of gas into audible signal, visual signal and deliver it to sensor board 12 and signal board 4 respectively, then the signal board 4 emits visual alarming signal through LED light emitting tube 4-1, and the sensor board 12 emits audible alarming signal through buzzer 13.

The invention has the following advantages: 1. The integrated design of the housing leads to cost saving, having the functions of gas detection, concentration display, adjusting remotely on field through infrared, 4-20 mA signal output, RS485 signal output, audible and visual alarming synchronously, and is able to achieve detection of more than 100 gases through using different sensors. 2. The whole stainless housing design leads to corrosion-resistance and suits for all kinds of bad environments. 3. Small size, light weight, which means it can be fitted conveniently. 4. Integrated junction box wiring, thereby avoiding water entering into the housing of main circuit. 5. The invention has got certification of explosion-proof, the explosion-proof grade is ExdllCT6. The product suits for the zone 1 and zone 2 of places where exist combustible gas or explosive mixtures formed by steam and air with llA, B, C grade, T1˜T6 temperature. The gas detector of the invention can be applied to places where combustible gas or poisonous gas might leaking out, such as refineries, chemical plants, etc, and can provide a long-term continuous monitoring to those sites. In a word, it is an important monitoring device to guarantee the safety of people and the plant.

The embodiment described above is merely a preferred specific embodiment of the invention, the person skilled in the art may make modifications and variations based on the technical solution, and all the modifications and variations based on the basic principle of the invention are within the scope of the invention defined in the appended claims.

1. An integrated gas detector integrating with audible and visual alarms, comprising:
an explosion-proof housing;
a gas detection unit disposed in the explosion-proof housing and used for detecting the concentration of gas; and a signal transducing unit disposed in the explosion-proof housing and used for receiving and processing the signal indicating the concentration of gas from the gas detection unit;
wherein, the explosion-proof housing comprises a cylinder shaped upper cover having an annular inward flange; the signal transducing unit and the gas detection unit are located at the two sides of the annular inward flange, and lean against the upper surface and the lower surface of the annular inward flange respectively, and are connected detachably and fixedly to each other by a fastening device,
the integrated gas detector integrating with audible and visual alarms further comprises a visual alarm unit and an audible alarm unit; the visual alarm unit being disposed at the side of the signal transducing unit; the audible alarm unit being disposed at the side of the gas detection unit; and when the signal transducing unit judges, basing on the signal indicating the concentration of gas, that the concentration of gas exceeds a preset alarm value, the visual alarm unit and the audible alarm unit will be triggered.

2. The integrated gas detector integrating with audible and visual alarms as claimed in claim 1, wherein the signal transducing unit comprises a power supply board, a current board, and a control panel, and the visual alarm unit comprises a signal board and a light emitting element provided on the signal board,
the power supply board leans against the upper surface of the annular inward flange, and the power supply board, the current board, the signal board, as well as the control panel are coupled with each other through pins for top to down and are detachably connected to each other by a fastening device, with insulated poles provided there between.

3. The integrated gas detector integrating with audible and visual alarms as claimed in claim 2, wherein the integrated gas detector further comprises a display unit, the display unit comprising a display panel, and a LED assembly disposed on the display panel, the display panel being provided over the control panel and connected by pins, the power supply board, the current board, the signal board, as well as the control panel and the display panel are coupled with each other through pins for top to down and are detachably connected to each other by a fastening device, with insulated poles provided there between.

4. The integrated gas detector integrating with audible and visual alarms as claimed in claim 2, wherein the gas detection unit comprises a sensor, a sensor board, and a sensor control panel, wherein, the sensor control panel leans against the lower surface of the annular inward flange and is connected detachably and fixedly to the fastening device, and the sensor is connected to the sensor board through pins, the sensor control panel is connected to the sensor board through pins.

5. The integrated gas detector integrating with audible and visual alarms as claimed in claim 4, wherein the gas detection unit further comprises a sensor fitting bracket, a first cross roundhead screw, and a copper connection pole, wherein, the sensor fitting bracket is connected and secured by the threaded connection between the first cross roundhead screw and the copper connection pole, the copper connection pole is connected securely to the fastening device through threaded connection.

6. The integrated gas detector integrating with audible and visual alarms as claimed in claim 4, wherein the audible alarm unit is disposed on the sensor board.

7. The integrated gas detector integrating with audible and visual alarms as claimed in claim 1, wherein a threaded hole running through the annular inward flange is formed, the threaded hole being connected securely to a connecting screw through threaded connection, cables passing through a rubber seal ring and then passing through the connecting screw, and the inside of the connecting screw being filled with epoxy resin.

8. The integrated gas detector integrating with audible and visual alarms as claimed in claim 7, wherein the explosion-proof housing further comprises a lamp cover and a stainless threaded ring, the lamp cover over which a first O-ring seal is disposed being connected securely to the stainless threaded ring through threaded connection, the stainless threaded ring over which a second O-ring seal is disposed being connected securely to the top cover through threaded connection.

9. The integrated gas detector integrating with audible and visual alarms as claimed in claim 8, wherein the explosion-proof housing further comprises a bottom cover and a stainless mesh assembly, the bottom cover being fitted with a fourth O-ring seal at its bottom and being connected securely to the stainless mesh assembly through threaded connection, the top cover over which a third O-ring seal is disposed being connected securely to the bottom cover.

10. An integrated gas detector integrating with audible and visual alarms, comprising a gas detection unit, a signal transducing unit, an audible and visual alarm unit, and an explosion-proof housing, wherein,
the gas detecting unit, the signal transducing unit, and the audible and visual alarming unit are disposed within the explosion-proof housing;
the gas detecting unit, the signal transducing unit, and the audible and visual alarming unit are connected sequentially;
the gas detection unit is used to detect the concentration of gas and deliver a signal comprising the concentration of gas to the signal transducing unit;
the signal transducing unit is used to convert the concentration of gas into a electrical signal for long-distance transmission; the signal indicating the concentration of gas will be transferred to the audible and visual alarming unit when the signal transducing unit judges that the concentration of gas exceeds the preset value;
the audible and visual alarming unit is used to convert the signal indicating the concentration of gas from signal transducing unit into audible and visual signal.
